(19) United States
(12) Patent Application Publication
(10) Pub. No.: US 2026/0107075 A1
(43) Pub. Date: Apr. 16, 2026

(54) RAMP GENERATOR AND IMAGING DEVICE INCLUDING THE SAME

(71) Applicant: SK hynix Inc., Gyeonggi-do (KR)

(72) Inventors: Yu Jin PARK, Gyeonggi-do (KR); Dong Ju KIM, Gyeonggi-do (KR); Jun Yeong LEE, Gyeonggi-do (KR)

(21) Appl. No.: 19/096,744

(22) Filed: Apr. 1, 2025

(30) Foreign Application Priority Data
Oct. 15, 2024 (KR) 10-2024-0140301

(51) Int. Cl. H04N 25/78; H04N 25/616

(52) U.S. Cl. CPC H04N 25/78; H04N 25/616

(57) ABSTRACT

An image sensing device includes a ramp generator configured to generate a ramp signal; a capacitance divider configured to output a first adjustment pixel signal by adjusting a voltage level range of a pixel signal to a first voltage level range value in a first analog gain mode, or configured to output a second adjustment pixel signal by adjusting a voltage level range of the pixel signal to a second voltage level range value in a second analog gain mode; and a signal controller configured to control the ramp generator so that a waveform of the ramp signal has a first slope in each of the first analog gain mode and the second analog gain mode.

### CROSS-REFERENCE TO RELATED APPLICATION

This patent application claims the priority and benefits of Korean patent application No. 10-2024-0140301, filed on Oct. 15, 2024, which is incorporated herein by reference in its entirety.

### TECHNICAL FIELD

The technology and embodiments disclosed in this patent application generally relate to a ramp generator capable of generating a high dynamic range (HDR) image, and an image sensing device including the same.

### BACKGROUND

An image sensing device captures optical images by converting light into electrical signals using a photosensitive semiconductor material which reacts to light. With the development of automotive, medical, computer and communication industries, the demand for high-performance image sensing devices has been increasing in various fields such as smartphones, digital cameras, game machines, Internet of Things (IoT), robots, surveillance cameras and medical micro cameras.

Recently, in order to provide high-quality images, interest in HDR images is rapidly increasing, and various techniques capable of acquiring HDR images are being developed. Among such techniques, technology for varying an analog gain that is used to convert an electrical signal indicating the intensity of incident light into digital data can contribute to obtaining HDR images, but there is an issue in that much more resources are consumed for hardware implementation for acquiring such HDR images.

### SUMMARY

Various embodiments of the present disclosure relate to a ramp generator capable of generating a high dynamic range (HDR) image with relatively simplified hardware, an image sensing device including the ramp generator, and a method for operating the image sensing device.

In accordance with an embodiment of the present disclosure, an image sensing device may include a ramp generator configured to generate a ramp signal; a capacitance divider configured to output a first adjustment pixel signal by adjusting a voltage level range of a pixel signal to a first voltage level range value in a first analog gain mode, or configured to output a second adjustment pixel signal by adjusting a voltage level range of the pixel signal to a second voltage level range value in a second analog gain mode; and a signal controller configured to control the ramp generator so that a waveform of the ramp signal has a first slope in each of the first analog gain mode and the second analog gain mode.

In accordance with another embodiment of the present disclosure, an image sensing device may include a pixel array configured to generate a pixel signal; a signal controller configured to generate a ramp control signal and a switch control signal based on an analog gain mode corresponding to illuminance; a capacitance divider configured to output a first adjustment pixel signal by adjusting a voltage level range of the pixel signal to a first voltage level range value based on the switch control signal, or configured to output a second adjustment pixel signal by adjusting a voltage level range of the pixel signal to a second voltage level range value; a ramp generator configured to adjust a slope of a ramp signal based on the ramp control signal; and a comparator configured to generate comparison data by comparing one of the first adjustment pixel signal or the second adjustment pixel signal with the ramp signal.

It is to be understood that both the foregoing general description and the following detailed description of the embodiments of the present disclosure are illustrative and descriptive, and are intended to provide further description of the embodiments as claimed.

### BRIEF DESCRIPTION OF THE DRAWINGS

The above and other features and beneficial aspects of the embodiments of the present disclosure will become readily apparent with reference to the following detailed description when considered in conjunction with the accompanying drawings.

FIG. 1 is a block diagram illustrating an imaging device according to an embodiment of the present disclosure.

FIG. 2 is a circuit diagram illustrating a pixel included in a pixel array of FIG. 1 according to an embodiment of the present disclosure.

FIG. 3 is a circuit diagram illustrating an analog-to-digital converter (ADC) shown in FIG. 1 according to an embodiment of the present disclosure.

FIG. 4 is a circuit diagram illustrating a cap divider included in the ADC shown in FIG. 3 according to an embodiment of the present disclosure.

FIG. 5 is a circuit diagram showing another cap divider included in the ADC shown in FIG. 3 according to an embodiment of the present disclosure.

FIG. 6 is a timing diagram illustrating voltage levels of an adjustment pixel signal that changes according to the opening and closing of a first switch shown in FIG. 5 according to the embodiments of the present disclosure.

FIGS. 7A to 7C are timing diagrams illustrating voltage levels of an adjustment pixel signal and an adjustment ramp signal that change according to signals shown in FIGS. 2 to 4.

### DETAILED DESCRIPTION

This patent application provides embodiments and examples of a ramp generator capable of generating a high dynamic range (HDR) image, an image sensing device including the ramp generation circuit, and a method for operating the image sensing device, that may be used in configurations to substantially address one or more technical or engineering issues and to mitigate limitations or disadvantages encountered in some other image sensing devices. Some embodiments of the present disclosure relate to a ramp generator capable of generating a high dynamic range (HDR) image with relatively simplified hardware, an image sensing device including the ramp generator, and a method for operating the image sensing device. In recognition of the issues above, the embodiments of the present disclosure can improve a signal to noise ratio (SNR) by compressing not only a ramp signal in a low-illuminance environment but also a voltage level range of a pixel signal in the low-illuminance environment. The embodiments of the present disclosure can reduce the circuit area and power consumption required to implement the ramp generator configured to use a plurality of analog gains.

Reference will now be made in detail to some embodiments of the present disclosure, examples of which are illustrated in the accompanying drawings. Wherever possible, the same reference numbers will be used throughout the drawings to refer to the same or like parts. While this disclosure is susceptible to various modifications and alternative forms, specific embodiments thereof are shown by way of example in the drawings. However, this disclosure should not be construed as being limited to the embodiments set forth herein.

Hereinafter, various embodiments of the present disclosure will be described with reference to the accompanying drawings. However, it should be understood that the embodiments of the present disclosure is not limited to specific embodiments, but include various modifications, equivalents and/or alternatives of the embodiments. The embodiments of the present disclosure may provide a variety of advantageous effects capable of being directly or indirectly recognized.

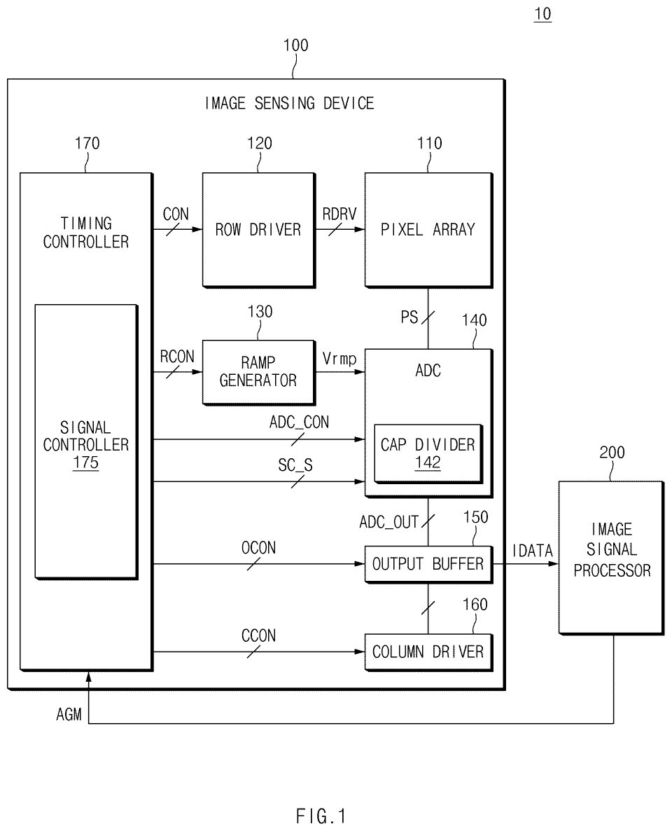

FIG. 1 is a block diagram illustrating an imaging device 10 according to embodiments of the present disclosure.

Referring to FIG. 1, the imaging device 10 may refer to a device, for example, a digital still camera for photographing still images or a digital video camera for photographing moving images. For example, the imaging device 10 may be implemented as a Digital Single Lens Reflex (DSLR) camera, a mirrorless camera, or a smartphone, and others. The imaging device 10 may include a device having both a lens and an image pickup element such that the device can capture (or photograph) a target object and can thus create an image of the target object.

The imaging device 10 may include an image sensing device 100 and an image signal processor (ISP) 200.

In some embodiments, the image sensing device 100 may be a complementary metal oxide semiconductor image sensor (CIS) for converting an incident light into an electrical signal. The image sensing device 100 may include a pixel array 110, a row driver 120, a ramp generator 130, an analog-to-digital converter (ADC) 140, an output buffer 150, a column driver 160, and a timing controller 170. The components of the image sensing device 100 illustrated in FIG. 1 are discussed by way of example only, and the present disclosure encompasses numerous other changes, substitutions, variations, alterations, and modifications.

The pixel array 110 may include a plurality of imaging pixels arranged in rows and columns. In one embodiment, the plurality of imaging pixels can be arranged in a two-dimensional (2D) pixel array including rows and columns. In another embodiment, the plurality of imaging pixels can be arranged in a three-dimensional (3D) pixel array. The plurality of imaging pixels may convert an optical signal into an electrical signal to output a pixel signal (PS) on a unit pixel basis or a pixel group basis, where pixels of a pixel group in the pixel array 110 share at least certain internal circuitry. The pixel array 110 may receive driving signals, including a row selection signal, a pixel reset signal and a transfer signal, from the row driver 120. Upon receiving a driving signal (RDRV), corresponding imaging pixels in the pixel array 110 may be activated to perform the operations corresponding to the row selection signal, the pixel reset signal, and the transfer signal.

The row driver 120 may activate the pixel array 110 to perform certain operations on the imaging pixels in the corresponding row based on commands and control signals (CON) provided by controller circuitry such as the timing controller 170. In some embodiments, the row driver 120 may select one or more imaging pixels arranged in one or more rows of the pixel array 110. The row driver 120 may generate a row selection signal to select one or more rows among the plurality of rows.

The row driver 120 may sequentially enable the pixel reset signal for resetting imaging pixels corresponding to at least one selected row, and the transfer signal for the pixels corresponding to the at least one selected row. Thus, a reference signal and an image signal, which are analog signals generated by each of the imaging pixels of the selected row, may be sequentially transferred to the ADC 140. The reference signal may be an electrical signal that is provided to the ADC 140 when a sensing node of an imaging pixel (e.g., floating diffusion node) is reset. The image signal may be an electrical signal that is provided to the ADC 140 when photocharges generated by the imaging pixel are accumulated in the sensing node. The reference signal indicating unique reset noise of each pixel and the image signal indicating the intensity of incident light may be generically called a pixel signal as necessary.

The ramp generator 130 may generate a ramp signal (Vrmp) required for the analog-to-digital conversion (ADC) operation of the ADC 140 according to a ramp control signal (RCON) received from the timing controller 170, and may supply the ramp signal (Vrmp) to the ADC 140. The ramp generator 130 may control a slope of the ramp signal (Vrmp) based on the ramp control signal (RCON). The ramp generator 130 may also be referred to as a ramp generation circuit.

CMOS image sensors may use the correlated double sampling (CDS) to remove undesired offset values of pixels known as the fixed pattern noise by sampling a pixel signal (PS) twice to remove the difference between these two samples. In one embodiment, the correlated double sampling (CDS) may remove the undesired offset value of pixels by comparing pixel output voltages obtained before and after photocharges generated by incident light are accumulated in the sensing node so that only pixel output voltages based on the incident light can be measured.

Upon receiving the control signal (ADC_CON) from the timing controller 170, the ADC 140 may sequentially sample and hold voltage levels of the reference signal and the image signal, which are provided to each of a plurality of column lines from the pixel array 110. That is, the ADC 140 may sample and hold the voltage levels of the reference signal and the image signal which correspond to each of the columns of the pixel array 110. In some embodiments, the ADC 140 may be implemented as a ramp-compare type ADC configured to use the ramp signal (Vrmp) of the ramp generator 130.

The ramp-compare type ADC may include a comparator circuit for comparing the analog pixel signal with a ramp signal that ramps up or down according to time, and a timer (or counter) for performing counting until a voltage of the ramp signal matches the analog pixel signal.

In some embodiments, ADC data (ADC_OUT) (i.e., image data IDATA) generated by the ADC 140 may correspond to at least two different sensitivities. The sensitivity may mean an increase in amount of image data IDATA (or an increase amount of a response) with respect to an increase in amount of the intensity of incident light. That is, as the sensitivity increases, the amount of increase in image data (IDATA) in response to an increase in the intensity of incident light increases. As the sensitivity decreases, the amount of increase in image data (IDATA) in response to an increase in the intensity of incident light decreases. In some embodiments, the term “sensitivity” may be determined by an analog gain in response to an analog gain mode (AGM). The analog gain may refer to a ratio of a voltage level of an analog pixel signal (PS) varying depending on the intensity of incident light to the size of image data (IDATA).

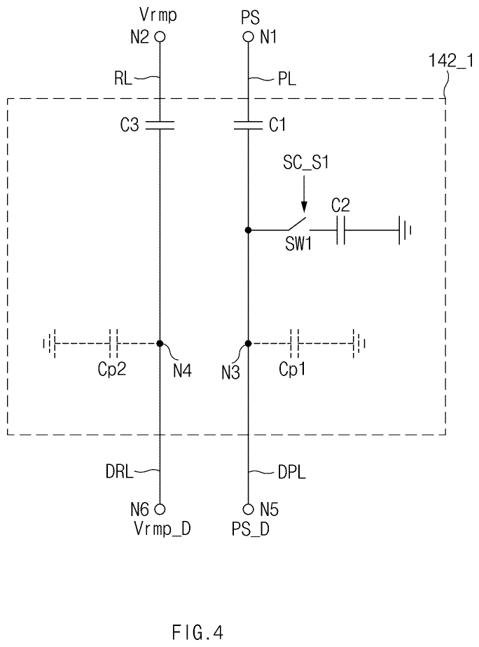

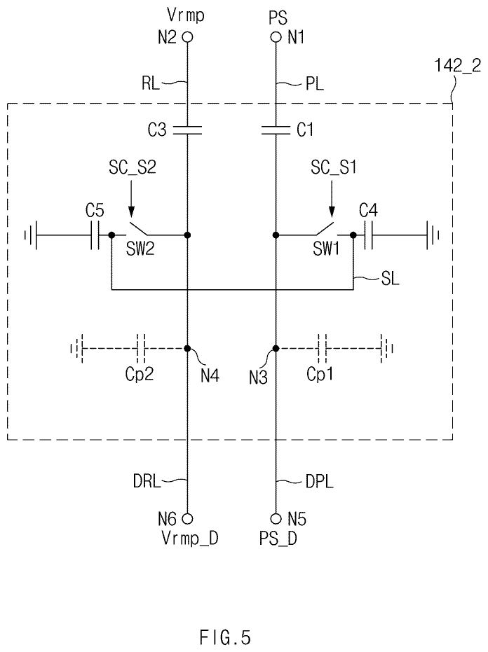

The ADC 140 may include a cap divider (capacitance divider) 142. The cap divider 142 may include constituent elements for performing a correlated double sampling (CDS) operation. In one embodiment, the cap divider 142 may include a capacitor and/or a switch that can adjust a voltage level range of a ramp signal (Vrmp) received from the ramp generator 130 and a voltage level range of the pixel signal (PS) received from the pixel of the pixel array 110. The voltage level range may mean a difference between a minimum voltage level and a maximum voltage level. A detailed configuration of the cap divider 142 will be described later with reference to FIGS. 4 and 5.

The output buffer 150 may temporarily hold the column-based ADC data (ADC_OUT) received from the ADC 140, and may output the image data (IDATA). The output buffer 150 may temporarily store ADC data (ADC_OUT) output from the ADC 140 based on an output control signal (OCON) received from the timing controller 170. The output buffer 150 may provide an interface to compensate for data rate differences or transmission rate differences between the image sensing device 100 and other devices (e.g., the image signal processor 200).

The column driver 160 may select a column of the output buffer 150 based on a control signal (CCON) received from the timing controller 170, and may control the output buffer 150 to sequentially output the image data (IDATA), which are temporarily stored in the selected column of the output buffer 150. In some embodiments, upon receiving an address signal from the timing controller 170, the column driver 160 may generate a column selection signal based on the address signal, and may select a column of the output buffer 150, thereby outputting the image data (IDATA) as an output signal from the selected column of the output buffer 150.

The timing controller 170 may control operations of at least one of the row driver 120, the ramp generator 130, the ADC 140, the output buffer 150, and the column driver 160.

The timing controller 170 may provide the row driver 120, the ramp generator 130, the ADC 140, the output buffer 150, and the column driver 160 with a clock signal required for the operations of the respective components of the image sensing device 100, a control signal for timing control, and address signals for selecting a row or column.

For example, the timing controller 170 may generate control signals (CON) for controlling the row driver 120. The timing controller 170 may generate a ramp control signal (RCON) for controlling the ramp generator 130. The timing controller 170 may generate a control signal (ADC_CON) for controlling the ADC 140. The timing controller 170 may generate an output control signal (OCON) for controlling the output buffer 150. The timing controller 170 may generate a column control signal (CCON) for controlling the column driver 160.

In some embodiments, the timing controller 170 may include a logic control circuit, a phase lock loop (PLL) circuit, a timing control circuit, a communication interface circuit and others.

The timing controller 170 may include a signal controller 175. The signal controller 175 may receive information about an analog gain mode (AGM) from the image signal processor (ISP) 200. In one embodiment, the signal controller 175 may generate a switch control signal (SC_S) for controlling the cap divider 142 based on the analog gain mode (AGM). The signal controller 175 may control a ramp control signal (RCON) based on the analog gain mode (AGM).

For example, the signal controller 175 may generate a switch control signal (SC_S) to control a switch included in the cap divider 142 to open or close. The signal controller 175 may control the ramp control signal (RCON) to control the slope of the ramp signal (Vrmp) generated by the ramp generator 130.

According to another embodiment, the signal controller 175 may generate a switch control signal (SC_S) so that a transistor included in the cap divider 142 can be turned on or off.

In the present disclosure, the signal controller 175 is illustrated as being located inside the timing controller 170 for convenience. Alternatively, the signal controller 175 may be located outside the timing controller 170 or may be included in the image signal processor (ISP) 200, and the installation position of the signal controller 175 is not limited thereto.

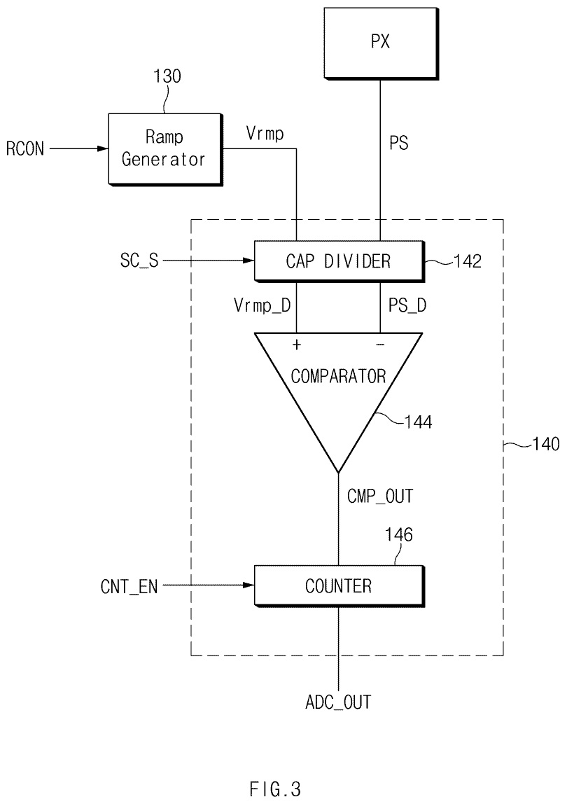

When the signal controller 175 is located outside the timing controller 170, the signal controller 175 may transmit a control signal to the timing controller 170. In addition, the timing controller 170 may generate a switch control signal (SC_S) that controls the cap divider 142 based on the received control signal. A detailed description of the operations of the signal controller 175 will be given later with reference to FIGS. 3 and 4.

The image signal processor (ISP) 200 may perform image processing of image data received from the image sensing device 100. The image signal processor (ISP) 200 may reduce noise of image data, and may perform various types of image signal processing (e.g. interpolation, synthesis, gamma correction, color filter array interpolation, color matrix, color correction, color enhancement, lens distortion correction, etc.) for image-quality improvement of the image data. In addition, the image signal processor (ISP) 200 may compress image data that has been created by execution of image signal processing for image-quality improvement, such that the image signal processor (ISP) 200 can create an image file using the compressed image data. Alternatively, the image signal processor (ISP) 200 may recover image data from the image file. In some embodiments, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created. For example, the image files may be created according to Exchangeable image file format (Exif) standards.

The image signal processor (ISP) 200 may generate an HDR image by synthesizing at least two images having different sensitivities. For example, the image sensing device 100 may output a low-sensitivity image generated by a low analog gain having a relatively lower sensitivity and a high-sensitivity image generated by a high analog gain having a relatively higher sensitivity. The image signal processor (ISP) 200 may combine the low-sensitivity image and the high-sensitivity image, resulting in formation of an HDR image. The low-sensitivity and the high-sensitivity may correspond to relative concepts. The image sensing device 100 may generate image data (IDATA) having at least N different sensitivities, where N is an integer of 2 or more. The image sensing processor (ISP) 200 may generate the HDR image using the resultant image data (IDATA).

The analog gain mode (AGM) for providing analog gain information to the image sensing device 100 may be set in the image signal processor (ISP) 200. In one embodiment, when the illuminance environment corresponds to the low-illuminance environment, the image signal processor (ISP) 200 may determine an analog gain mode (AGM) with a high gain value, and may provide information about the determined analog gain mode (AGM) to the image sensing device 100. On the other hand, when the illuminance environment corresponds to the high-illuminance environment, the image signal processor (ISP) 200 may determine an analog gain mode (AGM) with a low gain value, and may provide information about the determined analog gain mode (AGM) to the image sensing device 100.

In the present disclosure, the operation of setting the analog gain mode (AGM) in response to the illuminance environment by the image signal processor (ISP) 200 is described as an example for convenience, but the scope of the present disclosure is not limited thereto. Alternatively, the image sensing device 100 may determine the analog gain mode AGM upon receiving illuminance information from the image signal processor (ISP) 200, or may determine the analog gain mode AGM using an application processor (AP) (not shown) included in the imaging device 10.

The image signal processor (ISP) 200 or the application processor (AP) may determine a first analog gain mode in response to a first illuminance environment, and may determine a second analog gain mode in response to a second illuminance environment. The image signal processor (ISP) 200 or the application processor (AP) may transmit information about the determined analog gain mode to the image sensing device 100. For example, the image signal processor (ISP) 200 or the application processor (AP) may transmit information about the determined analog gain mode to the signal controller 175 included in the timing controller 170.

In some embodiments, the image signal processor (ISP) 200 may transmit the ISP image data to a host device. The host device may be a processor (e.g., an application processor) for processing the ISP image data received from the image signal processor (ISP) 200, a memory (e.g., a non-volatile memory) for storing the ISP image data, or a display device (e.g., a liquid crystal display (LCD)) for visually displaying the ISP image data. In addition, the image signal processor (ISP) 200 may transmit, to the image sensing device 100, a control signal for controlling operations (e.g., whether or not to operate, an operation timing, an operation mode, etc.) of the image sensing device 100.

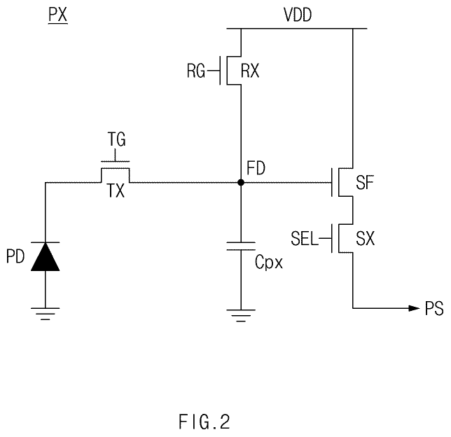

FIG. 2 is a circuit diagram illustrating a pixel (PX) included in the pixel array 110 of FIG. 1 according to some embodiments of the present disclosure.

Referring to FIG. 2, the pixel (PX) may be any of a plurality of pixels included in the pixel array 110. Although FIG. 2 shows only one pixel (PX) for convenience, other embodiments are also possible, and it should be noted that other pixels may also have substantially the same structure and operations as in the pixel (PX) without departing from the scope or spirit of the present disclosure.

The pixel (PX) may include a photoelectric conversion element (PD), a transfer transistor (TX), a reset transistor (RX), a floating diffusion region (FD), a pixel capacitor (Cₚₓ), a source follower transistor (SF), and a selection transistor (SX). Although FIG. 2 shows that the pixel (PX) includes only one photoelectric conversion element (PD), other embodiments are also possible, and it should be noted that the pixel (PX) can also be a shared pixel including a plurality of photoelectric conversion elements. In this case, the plurality of transfer transistors may be provided to correspond to the photoelectric conversion elements, respectively.

Each of the photoelectric conversion elements (PDs) may generate and accumulate photocharges corresponding to the intensity of incident light. For example, each of the photoelectric conversion elements (PDs) may be implemented as a photodiode, a phototransistor, a photogate, a pinned photodiode, or a combination thereof.

If the photoelectric conversion element (PD) is implemented as a photodiode, the photoelectric conversion element (PD) may be a region that is doped with second conductive impurities (e.g., N-type impurities) in a substrate including first conductive impurities (e.g., P-type impurities).

The transfer transistor (TX) may be coupled between the photoelectric conversion element (PD) and the floating diffusion region (FD). The transfer transistor (TX) may be turned on or off in response to a transfer control signal (TG). If the transfer transistor (TX) is turned on by a transfer signal (TG) of a logic high level, photocharges accumulated in the corresponding photoelectric conversion element (PD) can be transmitted to the floating diffusion region (FD).

The reset transistor (RX) may be disposed between the floating diffusion region (FD) and the power-supply voltage (VDD). The voltage of the floating diffusion region (FD) can be reset to the power-supply voltage (VDD) in response to a reset control signal (RG).

The floating diffusion region (FD) may accumulate photocharges received from the transfer transistor (TX). The floating diffusion region (FD) can be coupled to the pixel capacitor (Cₚₓ) connected to a ground terminal. For example, the floating diffusion region (FD) may be a region that is doped with second conductive impurities (e.g., N-type impurities) in a substrate (e.g., a P-type substrate) including first conductive impurities. In this case, the substrate and the impurity doped region can be modeled as the pixel capacitor (Cₚₓ) acting as a junction capacitor. The floating diffusion region (FD) may be referred to as a sensing node.

In some embodiments, a logic high level may mean a voltage level for activating (e.g., turning on) a corresponding element (e.g., a transistor), and a logic low level may mean a voltage level for deactivating (e.g., turning off) a corresponding element (e.g., a transistor).

Although FIG. 2 shows an example case in which the floating diffusion region (FD) having only one capacitance is used for convenience, other embodiments are also possible, and the floating diffusion region (FD) may also have two or more capacitances. For example, the floating diffusion region (FD) may selectively receive additional capacitance by connecting to a dual conversion gain (DCG) transistor, so that the floating diffusion region (FD) may have two capacitances.

The source follower transistor (SF) may be coupled between the selection transistor (SX) and the power-supply voltage (VDD), may amplify a change in electrical potential of the floating diffusion region (FD) that has received photocharges accumulated in the photoelectric conversion element (PD), and may transmit the amplified result to the selection transistor (SX).

The selection transistor (SX) may be coupled between the source follower transistor (SF) and the output signal line, and may be turned on by the selection control signal (SEL), so that the selection transistor (SX) can output the electrical signal received from the source follower transistor (SF) as the pixel signal (PS).

FIG. 3 is a circuit diagram illustrating an analog-to-digital converter (ADC) 140 according to the embodiments of the present disclosure.

Referring to FIG. 3, the ADC 140 may receive a ramp output signal (Vᵣₘₚ) from the ramp generator 130, may receive a pixel signal (PS) from the pixel (PX) of the pixel array 110, and may generate and output ADC data (ADC_OUT) based on the ramp output signal (Vᵣₘₚ) and the pixel signal (PS).

The ADC 140 may include a cap divider 142, a comparator 144, and a counter 146.

The cap divider 142 may receive a ramp signal (Vrmp) and may output an adjustment ramp signal (Vrmp_D). For example, the cap divider 142 may receive a ramp signal (Vrmp) having a first voltage level range and may output an adjustment ramp signal (Vrmp_D) having a second voltage level range. In one embodiment, the cap divider 142 may receive a pixel signal (PS) and may output an adjustment pixel signal (PS_D). For example, the cap divider 142 may receive a pixel signal (PS) having a first voltage level range and may output an adjustment pixel signal (PS_D) having a second voltage level range.

The ramp signal (Vrmp) and the pixel signal (PS) may be respectively converted into an adjustment ramp signal (Vrmp_D) and an adjustment pixel signal (PS_D) through the cap divider 142. The cap divider 142 may transfer the adjustment ramp signal (Vrmp_D) and the adjustment pixel signal (PS_D) to the comparator 144. The cap divider 142 may control at least one component included in the cap divider 142 based on a switch control signal (SC_S) to adjust a voltage level of the received pixel signal (PS). In one embodiment, the pixel signal (PS) having an adjusted voltage level may correspond to the adjustment pixel signal (PS_D). For example, the cap divider 142 may open or close at least one switch included in the cap divider 142 based on the switch control signal (SC_S).

The comparator 144 may compare the adjustment ramp signal (Vrmp_D) with the adjustment pixel signal (PS_D), may generate comparison data (CMP_OUT) according to the result of performing a comparison, and may transmit the comparison data (CMP_OUT) to the counter 146. When the adjustment ramp signal (Vrmp_D) is greater than the adjustment pixel signal (PS_D), the comparator 144 may generate comparison data (CMP_OUT) having a logic high level. When the adjustment ramp signal (Vrmp_D) is less than the adjustment pixel signal (PS_D), the comparator 144 may generate comparison data (CMP_OUT) having a logic low level. That is, the comparison data (CMP_OUT) may indicate the magnitude relationship between the adjustment ramp signal (Vrmp_D) and the adjustment pixel signal (PS_D).

The counter 146 may be activated in response to a counter enable signal (CNT_EN), the activated counter 146 may perform counting in response to the logic high level comparison data (CMP_OUT), and may output the counting result as ADC data (ADC_OUT). In some embodiments, the counter enable signal (CNT_EN) may be included in the control signal (ADC_CON) as shown in FIG. 1.

Referring to FIGS. 1 and 3, the signal controller 175 may cause a waveform of the ramp signal (Vrmp) to have a first slope in a first analog gain mode that is set based on the analog gain mode (AGM). In addition, the signal controller 175 may cause the voltage level range of the adjustment pixel signal (PS_D) to have a first range value in the first analog gain mode. In the present disclosure, the analog gain may mean a ratio of a voltage level of an analog pixel signal (PS) that varies depending on the intensity of incident light to the size of image data (IDATA). For example, the second analog gain mode may have an analog gain value greater than or equal to that of the first analog gain mode, and may have an analog gain value less than or equal to that of the third analog gain mode.

In the first analog gain mode that is set based on the analog gain mode (AGM), the ramp generator 130 may generate a ramp signal (Vrmp) including a waveform of a first reference slope based on a ramp control signal (RCON) received from the signal controller 175. In this mode, the cap divider 142 may receive the ramp signal (Vrmp) and may output an adjustment ramp signal (Vrmp_D) including a waveform of a first slope. In the first analog gain mode, the cap divider 142 may generate an adjustment pixel signal (PS_D) having a voltage level range of a first range value based on a switch control signal (SC_S) received from the signal controller 175.

In the second analog gain mode that is set based on the analog gain mode (AGM), the ramp generator 130 may generate a ramp signal (Vrmp) including a waveform of a first reference slope based on the ramp control signal (RCON) received from the signal controller 175. In this mode, the cap divider 142 may receive the ramp signal (Vrmp) and may output an adjustment ramp signal (Vrmp_D) including a waveform of a first slope. In the second analog gain mode, the cap divider 142 may generate an adjustment pixel signal (PS_D) having a voltage level range of a second range value based on the switch control signal (SC_S) received from the signal controller 175.

In the third analog gain mode that is set based on the analog gain mode (AGM), the ramp generator 130 may generate the ramp signal (Vrmp) including a waveform of a second reference slope based on the ramp control signal (RCON) received from the signal controller 175. In this mode, the cap divider 142 may receive the ramp signal (Vrmp) and may output an adjustment ramp signal (Vrmp_D) including a waveform of a second slope.

In the third analog gain mode, the cap divider 142 may generate an adjustment pixel signal (PS_D) having a voltage level range of a second range value based on the switch control signal (SC_S) received from the signal controller 175. In one embodiment, the first slope may correspond to a value greater than or equal to an absolute value of the second slope. In one embodiment, the second range value may correspond to a value greater than or equal to an absolute value of the first range value.

The signal controller 175 may control the cap divider 142 and the ramp generator 130 according to the first analog gain mode in the first illuminance environment, and may control the cap divider 142 and the ramp generator 130 according to the second analog gain mode in the second illuminance environment. In one embodiment, the first illuminance environment may correspond to a higher illuminance than the second illuminance environment.

The imaging device 10 may detect the external illuminance environment or the intensity of incident light to determine an appropriate analog gain. For example, the image signal processor (ISP) 200 may determine a high analog gain value when the external environment is dark, and may determine a low analog gain value when the external environment is bright. The image signal processor (ISP) 200 may adjust the signal controller 175 by transmitting information about the analog gain mode (AGM) to the signal controller 175 according to the determined analog gain. For example, based on the information about the analog gain mode (AGM) received from the image signal processor (ISP) 200, the signal controller 175 may generate signals corresponding to the first analog gain mode, the second analog gain mode, or the third analog gain mode.

FIG. 4 is a circuit diagram illustrating the cap divider 142_1 included in the ADC 140 shown in FIG. 3 according to an embodiment of the present disclosure.

Referring to FIG. 4, the cap divider 142_1 may include a pixel line (PL), a ramp line (RL), a first capacitor (C1), a second capacitor (C2), a third capacitor (C3), a first parasitic capacitor (Cₚ₁), a second parasitic capacitor (Cₚ₂), a first switch (SW1), an adjustment pixel line (DPL), and an adjustment ramp line (DRL).

The pixel line (PL) may receive a pixel signal (PS) from a first node (N1). The pixel line (PL) may receive the pixel signal (PS) and may transmit the pixel signal (PS) to the first capacitor (C1). Referring to FIG. 4 and FIG. 3, the pixel line (PL) may correspond to a line for connecting the pixel (PX) to the cap divider 142_1.

The ramp line (RL) may receive the ramp signal (Vrmp) from a second node (N2). The ramp line (RL) may receive the ramp signal (Vrmp) and may transmit the ramp signal (Vrmp) to the third capacitor (C3). Referring to FIG. 4 and FIG. 3, the ramp line (RL) may correspond to a line for connecting the ramp generator 130 to the cap divider 142_1. The first capacitor (C1) may receive the pixel signal (PS). The second capacitor (C2) connected through the first switch (SW1) may be connected to a third node (N3). In one embodiment, the first parasitic capacitor (Cₚ₁) may be connected to the third node (N3).

The third capacitor (C3) may receive the ramp signal (Vrmp). The second parasitic capacitor (Cₚ₂) may be connected to a fourth node (N4).

The first switch (SW1) may be opened or closed by the first switch control signal (SC_S1). The first switch control signal (SC_S1) may be generated by the signal controller 175 of FIG. 1 and may be transmitted to the first switch (SW1).

When the first switch (SW1) receives the first switch control signal (SC_S1) of the first logic level, the first switch (SW1) may be closed. When the first switch (SW1) receives the first switch control signal (SC_S1) of the second logic level, the first switch (SW1) may be opened.

Referring to FIG. 4 and FIG. 3, the adjustment pixel line (DPL) may transmit the adjustment pixel signal (PS_D) to a fifth node (N5). The pixel signal (PS) may be converted into the adjustment pixel signal (PS_D) by the cap divider 142_1. The adjustment pixel line (DPL) may transmit the adjustment pixel signal (PS_D) to the comparator 144 connected to the fifth node (N5).

Referring to FIG. 4 and FIG. 3, the adjustment ramp line (DRL) may be used to transmit the adjustment ramp signal (Vrmp_D) to a sixth node (N6). The ramp signal (Vrmp) may be converted into the adjustment ramp signal (Vrmp_D) by the cap divider 142_1. The adjustment ramp line (DRL) may be used to transmit the adjustment ramp signal (Vrmp_D) to the comparator 144 connected to the sixth node (N6).

Referring to FIGS. 1, 3 and 4, the signal controller 175 may generate a first switch control signal (SC_S1) of a first logic level in the first analog gain mode. The signal controller 175 may generate a ramp control signal (RCON) that controls the ramp generator 130 to generate the ramp signal (Vrmp) including a waveform of the first slope in the first analog gain mode.

The signal controller 175 may generate a first switch control signal (SC_S1) of a second logic level in the second analog gain mode. The signal controller 175 may generate the ramp control signal (RCON) that controls the ramp generator 130 to generate the ramp signal (Vrmp) including a waveform of the first slope in the second analog gain mode.

The signal controller 175 may generate a first switch control signal (SC_S1) of a second logic level in the third analog gain mode. The signal controller 175 may generate the ramp control signal (RCON) that controls the ramp generator 130 to generate the ramp signal (Vrmp) including a waveform of the second slope in the third analog gain mode. In one embodiment, the second slope may correspond to a slope that is smaller (gentler) than the first slope.

In the first analog gain mode, the first switch (SW1) may be closed by the first switch control signal (SC_S1). In this mode, the voltage level range of the pixel signal (PS) may be compressed. The pixel signal (PS) may be output as an adjustment pixel signal (PS_D), a voltage level range of which is adjusted through the cap divider 142_1.

In the first analog gain mode, when the voltage level range of the pixel signal (PS) is twice the voltage level range of the ramp signal (Vrmp), a method for matching the voltage level range of the adjustment pixel signal (PS_D) with the voltage level range of the adjustment ramp signal (Vrmp_D) may satisfy the following equations 1 to 5. ‘PS’ may correspond to a peak-to-peak voltage level (Vpp) of the pixel signal (PS), and ‘Vrmp’ may correspond to a peak-to-peak voltage level of the ramp signal (Vrmp).

In addition, PS_D may correspond to a peak-to-peak voltage level of the adjustment pixel signal (PS_D), and Vrmp_D may correspond to a peak-to-peak voltage level (Vpp) of the adjustment ramp signal (Vrmp_D).

C1 may correspond to a capacitance level (F) of the first capacitor (C1), C2 may correspond to a capacitance level (F) of the second capacitor (C2), and C3 may correspond to a capacitance level (F) of the third capacitor (C3). ‘Cp’ may correspond to capacitance levels (F) of the first parasitic capacitor (Cₚ₁) and the second parasitic capacitor (Cₚ₂). In the following equations, C1 is equal to C3 (i.e., C1=C3).

$$PS = 2 Vrmp \qquad Equation 1$$

$$Vrmp\_D = PS\_D \qquad Equation 2$$

$$PS\_D = ( C 1 / ( C 1 + C 2 + {C}_{p} ) ) ⋆ PS \qquad Equation 3$$

$$Vrmp\_D = C 3 / ( C 3 + {C}_{p} ) * Vrmp \qquad Equation 4$$

$$C 2 = C 1 + {C}_{p} \qquad Equation 5$$

In the first analog gain mode, the voltage level range of the pixel signal (PS) may be twice the voltage level range of the ramp signal (Vrmp). In addition, the voltage level range of the adjustment pixel signal (PS_D) and the voltage level range of the adjustment ramp signal (Vrmp_D) may be set to match each other. In this case, Equation 1 and Equation 2 must be satisfied.

In the first analog gain mode, when the first switch (SW1) is closed by the first switch control signal (SC_S1), the second capacitor (C2) and the first parasitic capacitor (Cₚ₁) may be connected in parallel between the ground terminal and the third node (N3).

A voltage level range of the pixel signal (PS) may be adjusted by capacitance distribution according to the connection relationship between the first capacitor (C1), the second capacitor (C2), and/or the first parasitic capacitor (Cₚ₁) so that the pixel signal (PS) can be converted into the adjustment pixel signal (PS_D). For example, the voltage level range of the pixel signal (PS) may be compressed into the voltage level range of the adjustment pixel signal (PS_D). The relationship between the voltage level range of the pixel signal (PS) and the voltage level range of the adjustment pixel signal (PS_D) may satisfy Equation 3. The above equations according to the embodiments of the present disclosure only represent tendencies, and the voltage level range of the pixel signal (PS) or the adjustment pixel signal (PS_D) is not limited thereto.

In the first analog gain mode, the third capacitor (C3) and the second parasitic capacitor (Cₚ₂) may be connected in series between the second node (N2) and the ground terminal. A voltage level range of the ramp signal (Vrmp) may be adjusted by capacitance distribution according to the connection relationship between the third capacitor (C3) and/or the second parasitic capacitor (Cₚ₂) so that the ramp signal (Vrmp) can be converted into the adjustment ramp signal (Vrmp_D). The relationship between the voltage level range of the ramp signal (Vrmp) and the voltage level range of the adjustment pixel signal (Vrmp_D) may satisfy Equation 4. The above equations according to the embodiments of the present disclosure only represent tendencies, and the voltage level range of the ramp signal (Vrmp) or the adjustment ramp signal (Vrmp_D) is not limited thereto.

When Equation 3 and Equation 4 are substituted into Equation 2, and Equation 1 is then applied to the resultant Equation 2, Equation 5 can be obtained. For example, in the first analog gain mode, the voltage level range of the pixel signal (PS) is 1 [Vpp], the voltage level range of the ramp signal (Vrmp) is 0.5 [Vpp], C1=C3=200 [fF], and Cₚ=20 [fF]. In this embodiment, referring to Equation 5, a capacitance level of the second capacitor (C2) for matching the voltage level range of the adjustment pixel signal (PS_D) with the voltage level range of the adjustment ramp signal (Vrmp_D) may correspond to 220 [fF]. In this embodiment, referring to Equation 3, the voltage level range of the adjustment pixel signal (PS_D) may correspond to 0.4545 [Vpp]. Referring to Equation 4, the voltage level range of the adjustment ramp signal (Vrmp_D) may correspond to 0.4545 [Vpp].

The voltage level range of the pixel signal (PS) must be within the input range of the comparator 144. For example, the comparator 144 may generate valid ADC data (ADC_OUT) for the pixel signal (PS) within the input range. When the first switch (SW1) is closed by the first switch control signal (SC_S1), the voltage level range of the pixel signal (PS) may be compressed through capacity distribution according to the connection relationship between the first capacitor (C1), the second capacitor (C2), and the first parasitic capacitor (Cₚ₁). The cap divider 142 may generate the adjustment pixel signal (PS_D) by compressing the voltage level range of the pixel signal (PS). The comparator 144 may generate valid ADC data (ADC_OUT) for the pixel signal (PS) having a wide range of voltage levels based on the adjustment pixel signal (PS_D). That is, the imaging device 10 may obtain a high dynamic range (HDR) image by using the cap divider 142.

Referring to FIG. 5 and FIG. 1, the signal controller 175 may control the ramp generator 130 and/or the cap divider 142 according to the analog gain mode (AGM) in order to reduce noise generated in the process of compressing the pixel signal (PS). In the present disclosure, the term “noise” refers to not only noise that means the degree of mismatch between the intensity of incident light incident upon the image sensing device 100 and the voltage level of the corresponding pixel signal (PS), but also noise generated in the circuit within the imaging device 10.

According to one embodiment, when the waveform of the ramp signal (Vrmp) has a sharp slope, noise may be reduced. In one embodiment, when the ramp signal (Vrmp) is not compressed and only the voltage level range of the pixel signal (PS) is compressed, the signal to noise ratio (SNR) can be maintained or improved compared to the example case where the ramp signal (Vrmp) and the pixel signal (PS) are compressed simultaneously.

In the first analog gain mode, the signal controller 175 may allow the noise, which is generated as the input signal is reduced by compression of the voltage level range of the pixel signal PS, to correspond to the ramp signal (Vrmp) having the waveform of the first slope indicating a relatively sharp slope. In addition, the signal controller 175 may cause the ramp signal (Vrmp) to have a waveform of the first slope without compressing the voltage level range of the pixel signal (PS) in the second analog gain mode.

The signal controller 175 may cause the ramp signal (Vrmp) to have a waveform of the first slope in each of the first analog gain mode and the second analog gain mode. In each of the first analog gain mode and the second analog gain mode, the signal controller 175 may cause the ramp signal (Vrmp) to have the waveform of the first slope, constituent elements (e.g., a ramp signal control switch, etc.) for changing the slope of the ramp signal (Vrmp) can be omitted, or a physical size and/or power consumption of the image sensing device 100 can be reduced.

The signal controller 175 may close the first switch (SW1) of the cap divider 142_1 in the first analog gain mode, and may open the first switch (SW1) of the cap divider 142_1 in the second analog gain mode.

FIG. 5 is a circuit diagram showing another cap divider 142_2 included in the ADC 140 shown in FIG. 3 according to an embodiment of the present disclosure.

Referring to FIG. 5, the cap divider 142_2 may include a pixel line (PL), a ramp line (RL), a first capacitor (C1), a third capacitor (C3), a fourth capacitor (C4), a fifth capacitor (C5), a first parasitic capacitor (Cₚ₁), a second parasitic capacitor (Cₚ₂), a first switch (SW1), a second switch (SW2), a shared line (SL), an adjustment pixel line (DPL), and an adjustment ramp line (DRL).

The pixel line (PL) may receive a pixel signal (PS) from a first node (N1). The pixel line (PL) may receive the pixel signal (PS) and may transmit the pixel signal (PS) to the first capacitor (C1). Referring to FIG. 5 and FIG. 3, the pixel line (PL) may correspond to a line for connecting the pixel (PX) to the cap divider 142_2.

The ramp line (RL) may receive the ramp signal (Vrmp) from a second node (N2). The ramp line (RL) may receive the ramp signal (Vrmp) and may transmit the ramp signal (Vrmp) to the third capacitor (C3). Referring to FIG. 5 and FIG. 3, the ramp line (RL) may correspond to a line for connecting the ramp generator 130 to the cap divider 142_2.

The first capacitor (C1) may receive the pixel signal (PS). The fourth capacitor (C4) connected through the first switch (SW1) may be connected to a third node (N3). In one embodiment, the first parasitic capacitor (Cₚ₁) may be connected to the third node (N3).

The third capacitor (C3) may receive the ramp signal (Vrmp). The fifth capacitor (C5) may be connected between the shared line (SL) and the ground terminal. In one embodiment, the second parasitic capacitor (Cₚ₂) may be connected to the fourth node (N4).

The first switch (SW1) may be opened or closed by the first switch control signal (SC_S1). Referring to FIG. 5 and FIG. 1, the first switch control signal (SC_S1) may be generated by the signal controller 175 and may be transmitted to the first switch (SW1).

When the first switch (SW1) receives the first switch control signal (SC_S1) of the first logic level, the first switch (SW1) may be closed. When the first switch (SW1) receives the first switch control signal (SC_S1) of the second logic level, the first switch (SW1) may be opened.

The second switch (SW2) may receive the second switch control signal (SC_S2). Referring to FIG. 5 and FIG. 1, the second switch control signal (SC_S2) may be generated by the signal controller (175) and may be transmitted to the second switch (SW2).

The shared line (SL) may connect the node for connecting the first switch (SW1) to the fourth capacitor (C4) to the other node for connecting the second switch (SW2) to the fifth capacitor (C5). The second switch (SW2) may be set to always be open by the second switching control signal (SC_S2). When the second switch (SW2) is open, the fourth capacitor (C4) and the fifth capacitor (C5) may be connected in parallel between the ground terminal and the node for connecting the first switch (SW1) to the fourth capacitor (C4).

For example, the sum (i.e., sum of capacitances of the capacitors) of the fourth capacitor (C4) and the fifth capacitor (C5) may be equal to a value (i.e., capacitance value) of the second capacitor (C2) of FIG. 4. Since the first capacitor (C1), the first switch (SW1), and the fourth capacitor (C4) connected to the node (N3) have a symmetrical structure with the third capacitor (C3), the second switch (SW2), and the fifth capacitor (C5) connected to the node (N4), noise at the nodes (N3, N4) can be canceled out. Accordingly, the second switch (SW2) may be set to be open at all times, and the voltage level of the adjustment pixel signal (PS_D) may be changed in response to capacitances of the first capacitor (C1), the fourth capacitor (C4), and the fifth capacitor (C5) connected to the fourth capacitor (C4) through the shared line (SL) according to the opening and closing of the first switch (SW1). In the present disclosure, the sum of capacitance of the fourth capacitor (C4) and capacitance of the fifth capacitor (C5) is set to be equal to the capacitance of the second capacitor (C2), but the scope of the present disclosure is limited thereto, the capacitance of the fourth capacitor (C4) may be different from the capacitance of the fifth capacitor (C5), and the ratio of the capacitance of the fourth capacitor (C4) to the capacitance of the fifth capacitor (C5) can be sufficiently changed.

Referring to FIG. 5 and FIG. 3, the adjustment pixel line (DPL) may transmit the adjustment pixel signal (PS_D) to the fifth node (N5). The pixel signal (PS) may be converted into the adjustment pixel signal (PS_D) through the cap divider 142_2. The adjustment pixel line (DPL) may transmit the adjustment pixel signal (PS_D) to the comparator 144 connected to the fifth node (N5).

Referring to FIG. 5 and FIG. 3, the adjustment ramp line (DRL) may be used to transmit the adjustment ramp signal (Vrmp_D) to the sixth node (N6). The ramp signal (Vrmp) may be converted into the adjustment ramp signal (Vrmp_D) through the cap divider 142_2. The adjustment ramp line (DRL) may be used to transmit the adjustment ramp signal (Vrmp_D) to the comparator 144 connected to the sixth node (N6).

Referring to FIG. 5 and FIG. 3, the signal controller 175 may generate the first switch control signal (SC_S1) of the first logic level in the first analog gain mode. In addition, the signal controller 175 may generate the second switch control signal (SC_S2) of the second logic level in the first analog gain mode. In the first analog gain mode, the signal controller 175 may generate a ramp control signal (RCON) that controls the ramp generator 130 to generate the ramp signal (Vrmp) including a waveform of the first slope.

The signal controller 175 may generate a first switch control signal (SC_S1) of a second logic level in the second analog gain mode. In addition, the signal controller 175 may generate a second switch control signal (SC_S2) of a second logic level in the second analog gain mode. In the second analog gain mode, the signal controller 175 may generate a ramp control signal (RCON) that controls the ramp generator 130 to generate the ramp signal (Vrmp) including a waveform of the first slope.

The signal controller 175 may generate a first switch control signal (SC_S1) of a second logic level in the third analog gain mode. In addition, the signal controller 175 may generate a second switch control signal (SC_S2) of a second logic level in the third analog gain mode. In the third analog gain mode, the signal controller 175 may generate a ramp control signal (RCON) that controls the ramp generator 130 to generate the ramp signal (Vrmp) including a waveform of the second slope.

In the first analog gain mode, the first switch (SW1) may be closed by the first switch control signal (SC_S1), and the second switch (SW2) may be opened by the second switch control signal (SC_S2). In this mode, the voltage level range of the pixel signal (PS) may be compressed. The pixel signal (PS) may be output as an adjustment pixel signal (PS_D), a voltage level range of which is adjusted through the cap divider 142_1.

In the first analog gain mode, when the voltage level range of the pixel signal (PS) is twice the voltage level range of the ramp signal (Vrmp), a method for matching the voltage level range of the adjustment pixel signal (PS_D) with the voltage level range of the adjustment ramp signal (Vrmp_D) may satisfy the following equations 6 to 10. ‘PS’ may correspond to a peak-to-peak voltage level (Vpp) of the pixel signal (PS), and ‘Vrmp’ may correspond to a peak-to-peak voltage level of the ramp signal (Vrmp).

In addition, PS_D may correspond to a peak-to-peak voltage level of the adjustment pixel signal (PS_D), and Vrmp_D may correspond to a peak-to-peak voltage level (Vpp) of the adjustment ramp signal (Vrmp_D). C1 may correspond to a capacitance level (F) of the first capacitor (C1), C4 may correspond to a capacitance level (F) of the fourth capacitor (C4), C3 may correspond to a capacitance level (F) of the third capacitor (C3), and C5 may correspond to a capacitance level (F) of the fifth capacitor (C5). ‘Cp’ may correspond to capacitance levels (F) of the first parasitic capacitor (Cₚ₁) and the second parasitic capacitor (Cₚ₂). In the following equations, C1 is equal to C3 (i.e., C1=C3) and C4 is equal to C5 (i.e., C4=C5).

$$PS = 2 Vrmp \qquad Equation 6$$

$$Vrmp\_D = PS\_D \qquad Equation 7$$

$$PS\_D = ( C 1 / ( C 1 + C 4 + C 5 + {C}_{p} ) ) ⋆ PS \qquad Equation 8$$

$$Vrmp\_D = C 3 / ( C 3 + {C}_{p} ) * Vrmp \qquad Equation 9$$

$$2 * C 4 = C 1 + {C}_{p} \qquad Equation 10$$

In the first analog gain mode, the voltage level range of the pixel signal (PS) may be twice the voltage level range of the ramp signal (Vrmp). In addition, the voltage level range of the adjustment pixel signal (PS_D) and the voltage level range of the adjustment ramp signal (Vrmp_D) may be set to match each other. In this case, Equation 6 and Equation 7 must be satisfied.

In the first analog gain mode, when the first switch (SW1) is closed by the first switch control signal (SC_S1), the fourth capacitor (C4) and the first parasitic capacitor (Cₚ₁) may be connected in parallel between the ground terminal and the third node (N3). Since the second switch (SW2) is open, the fourth capacitor (C4) and the fifth capacitor (C5) may be connected in parallel between the ground terminal and the node for connecting the first switch (SW1) to the fourth capacitor (C4). That is, the fourth capacitor (C4), the third capacitor (C3), and the first parasitic capacitor (Cₚ₁) may be connected in parallel between the ground terminal and the third node (N3).

A voltage level range of the pixel signal (PS) may be adjusted by capacitance distribution according to the connection relationship between the first capacitor (C1), the fourth capacitor (C4), the fifth capacitor (C5), and/or the fifth parasitic capacitor (Cₚ₁) so that the pixel signal (PS) can be converted into the adjustment pixel signal (PS_D). For example, the voltage level range of the pixel signal (PS) may be compressed into the voltage level range of the adjustment pixel signal (PS_D). The relationship between the voltage level range of the pixel signal (PS) and the voltage level range of the adjustment pixel signal (PS_D) may satisfy Equation 8. The above equations according to the embodiments of the present disclosure only represent tendencies, and the voltage level range of the pixel signal (PS) or the adjustment pixel signal (PS_D) is not limited thereto.

In the first analog gain mode, the third capacitor (C3) and the second parasitic capacitor (Cₚ₂) may be connected in series between the second node (N2) and the ground terminal. For example, a voltage level range of the ramp signal (Vrmp) may be adjusted by capacitance distribution according to the connection relationship between the third capacitor (C3) and/or the second parasitic capacitor (Cₚ₂) so that the ramp signal (Vrmp) can be converted into the adjustment ramp signal (Vrmp_D). The relationship between the voltage level range of the ramp signal (Vrmp) and the voltage level range of the adjustment pixel signal (Vrmp_D) may satisfy Equation 9. The above equations according to the embodiments of the present disclosure only represent tendencies, and the voltage level range of the ramp signal (Vrmp) or the adjustment ramp signal (Vrmp_D) is not limited thereto.

When Equation 8 and Equation 9 are substituted into Equation 7, and Equation 6 is then applied to the resultant Equation 7, Equation 10 can be obtained. For example, in the first analog gain mode, the voltage level range of the pixel signal (PS) is 1 [Vpp], the voltage level range of the ramp signal (Vrmp) is 0.5 [Vpp], C1=C3=200 [fF], and Cₚ=20 [fF]. In this embodiment, referring to Equation 10, a capacitance level of the fourth capacitor (C4) for matching the voltage level range of the adjustment pixel signal (PS_D) with the voltage level range of the adjustment ramp signal (Vrmp_D) may correspond to 110 [fF]. In this embodiment, referring to Equation 8, the voltage level range of the adjustment pixel signal (PS_D) may correspond to 0.4545 [Vpp]. Referring to Equation 9, the voltage level range of the adjustment ramp signal (Vrmp_D) may correspond to 0.4545 [Vpp].

The cap divider 142_2 may symmetrically arrange the pixel line (PL), the ramp line (RL), the first capacitor (C1), the fourth capacitor (C4), the third capacitor (C3), the fifth capacitor (C5), the first parasitic capacitor (Cₚ₁), the second parasitic capacitor (Cₚ₂), the first switch (SW1), the second switch (SW2), and the shared line (SL) to minimize the influence of external noise.

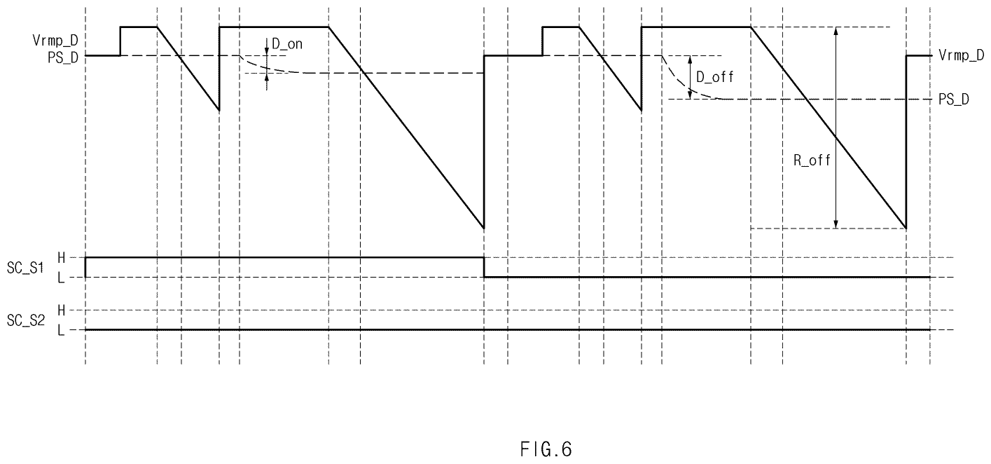

FIG. 6 is a timing diagram illustrating voltage levels of the adjustment pixel signal that changes according to the opening and closing of the first switch SW1 shown in FIG. 5 according to the embodiments of the present disclosure.

Referring to FIGS. 2 to 4 and FIG. 6, when the first switch (SW1) is closed based on the first switch control signal (SC_S1) of a logic high level (H), the voltage level range of the adjustment pixel signal (PS_D) may correspond to the adjustment range (D_on). When the first switch (SW1) is open based on the first switch control signal (SC_S1) of a logic low level (L), the voltage level range of the adjustment pixel signal (PS_D) may correspond to the reference range (D_off).

The voltage level range of the pixel signal (PS) may be greater than or equal to the reference range (D_off). The voltage level range of the pixel signal (PS) may be reduced due to capacity distribution according to the connection relationship between the first capacitor (C1), the second capacitor (C2), and/or the first parasitic capacitor (Cₚ₁). The pixel signal (PS) with the reduced voltage level range may be output as the adjustment pixel signal (PS_D).

While the second switch (SW2) is open based on the second switch control signal (SC_S2) of a logic low level (L), the voltage level range of the adjustment ramp signal (Vrmp_D) may correspond to the reference ramp range (R_off). In one embodiment, while the first switch (SW1) is opened or closed, the second switch (SW2) may be set to be open. For example, in each of the first analog gain mode and the second analog gain mode, the second switch (SW2) may be set to always be open, so that the voltage level range of the adjustment ramp signal (Vrmp_D) may be maintained at the reference ramp range (R_off).

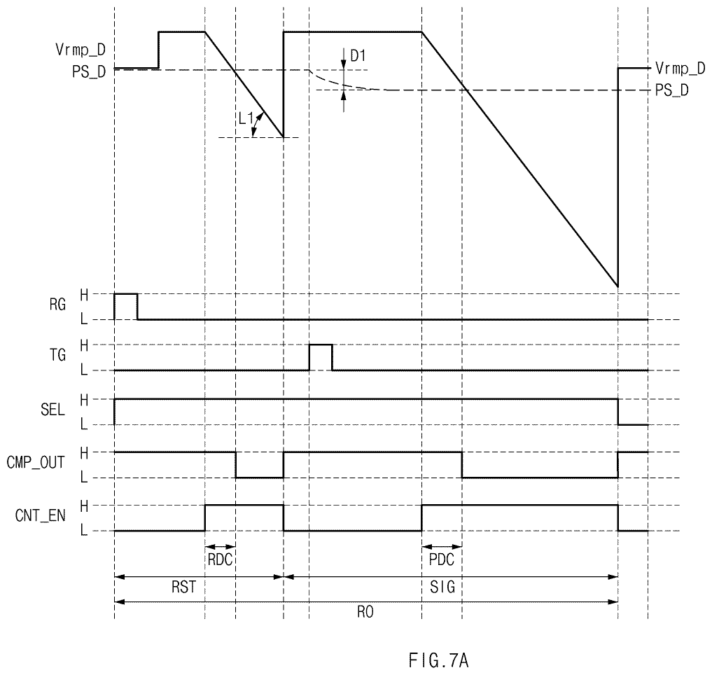

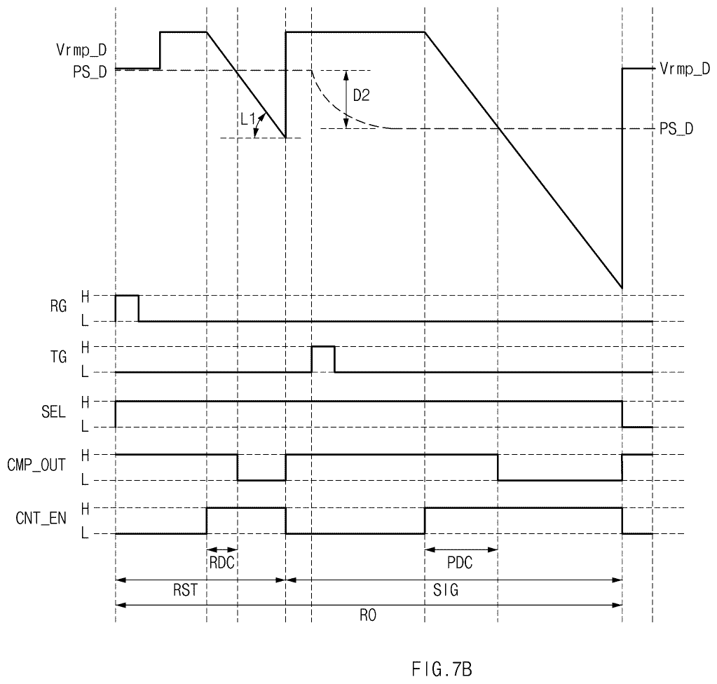

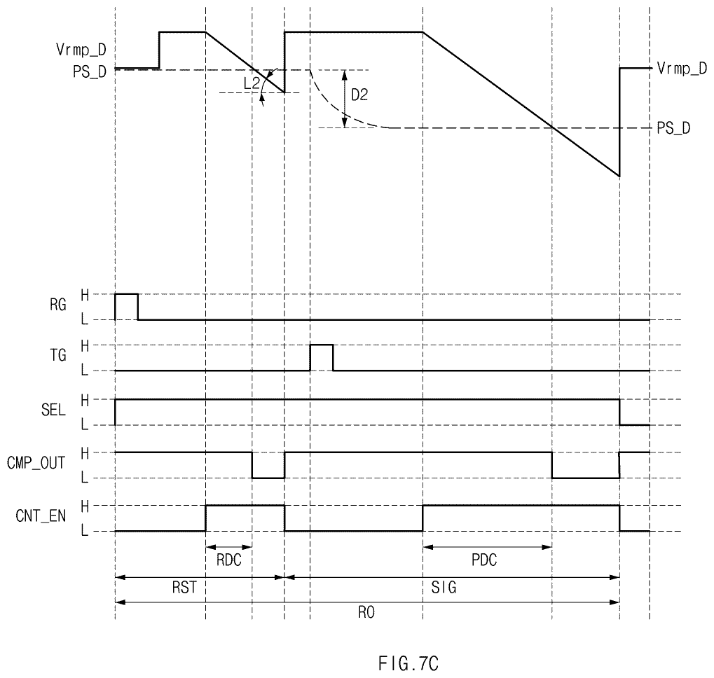

A detailed description of the pixel reset signal (RG), the transfer signal (TG), and the selection control signal (SEL) that affect the voltage level of the adjustment pixel signal (PS_D) will be given later with reference to FIGS. 7A to 7C.

FIGS. 7A to 7C are timing diagrams illustrating voltage levels of the adjustment pixel signal PS_D and the adjustment ramp signal Vrmp_D that change according to signals shown in FIGS. 2 to 4.

Referring to FIGS. 2 to 4 and FIG. 7A, in the first analog gain mode, the operation of converting the adjustment pixel signal (PS_D) into image data (IDATA) may be performed during a readout period (RO). In one embodiment, the readout period (RO) may correspond to a time period in which the ADC 140 receives the pixel signal (PS) from the source follower transistor (SF) based on the selection control signal (SEL) of a logic high level (H).

The pixel signal (PS) may be converted into the adjustment pixel signal (PS_D) by passing through the cap divider 142. The adjustment pixel signal (PS_D) may be divided into a reference signal and an image signal. The readout period (RO) may correspond to a time period in which the reference signal and the image signal are converted into digital values.

The first analog gain mode may be a mode in which an increase in the response (or image data) according to an increase in the intensity of incident light corresponds to a first gain value. In one embodiment, the first gain value of the first analog gain mode may correspond to a value that is less than or equal to each of a second gain value of the second analog gain mode and a third gain value of the third analog gain mode.

The readout period (RO) may be divided into a reset period (RST) and a signal period (SIG). The reset period (RST) may be a time period in which the reference signal is subjected to ADC (analog-to-digital conversion). The signal period (SIG) may be a time period in which the image signal is subjected to ADC.

In the reset period (RST), since a pixel reset signal (RG) temporarily has a logic high level (H), a pixel signal (PS) corresponding to the voltage of the reset floating diffusion region (FD) may be output from the pixel (PX). The pixel signal (PS) corresponding to a voltage of the reset floating diffusion region (FD) may be converted into the adjustment pixel signal (PS_D) by passing through the cap divider 142.

The comparison data (CMP_OUT) may have a logic high level (H) in a time section where the adjustment ramp signal (Vrmp_D) is greater than the adjustment pixel signal (PS_D), and may have a logic low level (L) in a time section where the adjustment ramp signal (Vrmp_D) is less than the adjustment pixel signal (PS_D).

A counter enable signal (CNT_EN) may have a logic high level (H) in a time section where the adjustment ramp signal (Vrmp_D) has a first slope (L1) that is a negative (−) slope. The counter 146 may be activated in response to the counter enable signal (CNT_EN) having a logic high level (H).

The activated counter 146 may perform counting in a time section where the comparison data (CMP_OUT) has a logic high level (H), and may output the counting result as ADC data (ADC_OUT). The ADC-processed reference signal may correspond to a result value counted by the counter 146 during a reset data counting period (RDC).

In the signal period (SIG), since the transfer signal (TG) temporarily has a logic high level (H), a pixel signal (PS) corresponding to a voltage of the floating diffusion region (FD) in which photocharges generated by the pixel (PX) are accumulated may be output from the pixel (PX). The voltage level of the pixel signal (PS) may be lowered in response to the amount of photocharges accumulated in the floating diffusion region (FD).

The pixel signal (PS) with the lowered voltage level may be converted into the adjustment pixel signal (PS_D) with the lowered voltage level by passing through the cap divider 142. The adjustment pixel signal (PS_D) in the signal period (SIG) may have a lower voltage level than the adjustment pixel signal (PS_D) in the reset period (RST) by a first range value (D1).

After lapse of a predetermined time from the beginning of the signal period (SIG), the ramp generator 130 may output a ramp output signal (Vrmp) having a first slope (L1) that is a negative (−) slope. The first slope (L1) of the ramp output signal (Vrmp) may be the same as the first slope (L1) of the ramp output signal (Vrmp) in the reset period (RST).

The comparison data (CMP_OUT) may have a logic high level (H) in a time section where the adjustment ramp signal (Vrmp_D) is greater than the adjustment pixel signal (PS_D), and may have a logic low level (L) in a time section where the adjustment ramp signal (Vrmp_D) is less than the adjustment pixel signal (PS_D).

The counter enable signal (CNT_EN) may have a logic high level (H) in a time section where the adjustment ramp signal (Vrmp_D) has a first slope (L1) that is a negative (−) slope. The counter 146 may be activated in response to the counter enable signal (CNT_EN) having a logic high level (H).

The activated counter 146 may perform counting in a time section where the comparison data (CMP_OUT) has a logic high level (H), and may output the counting result as ADC data (ADC_OUT). The ADC-processed image signal may correspond to a result value counted by the counter 146 during a pixel data counting period (PDC).

In the first analog gain mode, a value corresponding to a voltage difference between the image signal and the reference signal (i.e., a signal component from which reset noise is removed) may be obtained by subtracting a value obtained by AD-converting the reference signal from a value obtained by AD-converting the image signal.

Referring to FIGS. 2 to 4 and FIG. 7B, in the second analog gain mode, the operation of converting the adjustment pixel signal (PS_D) into image data may be performed during the readout period (RO). The readout period (RO) may correspond to a time period in which the ADC 140 receives the pixel signal (PS) from the source follower transistor (SF) based on the selection control signal (SEL) of a logic high level (H).

The pixel signal (PS) may be converted into the adjustment pixel signal (PS_D) by passing through the cap divider 142. The adjustment pixel signal (PS_D) may be divided into a reference signal and an image signal. The readout period (RO) may correspond to a time period in which the reference signal and the image signal are converted into digital values.

The second analog gain mode may be a mode in which an increase in the response (or image data) according to an increase in the intensity of incident light corresponds to a second gain value. In one embodiment, the second gain value of the second analog gain mode may correspond to a value that is greater than or equal to a first gain value of the first analog gain mode. The second gain value of the second analog gain mode may correspond to a value less than or equal to a third gain value of the third analog gain mode.

The readout period (RO) may be divided into a reset period (RST) and a signal period (SIG). The reset period (RST) may be a time period in which the reference signal is subjected to ADC. The signal period (SIG) may be a time period in which the image signal is subjected to ADC.

In the reset period (RST), since the pixel reset signal (RG) temporarily has a logic high level (H), a pixel signal (PS) corresponding to the voltage of the reset floating diffusion region (FD) may be output from the pixel (PX). The pixel signal (PS) corresponding to the voltage of the reset floating diffusion region (FD) may be converted into the adjustment pixel signal (PS_D) by passing through the cap divider 142.

The comparison data (CMP_OUT) may have a logic high level (H) in a time section where the adjustment ramp signal (Vrmp_D) is greater than the adjustment pixel signal (PS_D), and may have a logic low level (L) in a time section where the adjustment ramp signal (Vrmp_D) is less than the adjustment pixel signal (PS_D).

The counter enable signal (CNT_EN) may have a logic high level (H) in a time section where the adjustment ramp signal (Vrmp_D) has a first slope (L1) that is a negative (−) slope. The counter 146 may be activated in response to the counter enable signal (CNT_EN) having a logic high level (H).

The activated counter 146 may perform counting in a time section where the comparison data (CMP_OUT) has a logic high level (H), and may output the counting result as ADC data (ADC_OUT). The ADC-processed reference signal may correspond to a result value counted by the counter 146 during the reset data counting period (RDC).

In the signal period (SIG), since the transfer signal (TG) temporarily has a logic high level (H), the pixel signal (PS) corresponding to the voltage of the floating diffusion region (FD) in which photocharges generated by the pixel (PX) are accumulated may be output from the pixel (PX). The voltage level of the pixel signal (PS) may be lowered in response to the amount of photocharges accumulated in the floating diffusion region (FD).

The pixel signal (PS) with the lowered voltage level may be converted into the adjustment pixel signal (PS_D) with the lowered voltage level by passing through the cap divider 142. The control pixel signal (PS_D) in the signal period (SIG) may have a lower voltage level than the adjustment pixel signal (PS_D) in the reset section (RST) by a second range value (D2).

After lapse of a predetermined time from the beginning of the signal period (SIG), the ramp generator 130 may output a ramp output signal (Vrmp) having a first slope (L1) that is a negative (−) slope. The first slope (L1) of the ramp output signal (Vrmp) may be the same as the first slope (L1) of the ramp output signal (Vrmp) in the reset period (RST).

The comparison data (CMP_OUT) may have a logic high level (H) in a time section where the adjustment ramp signal (Vrmp_D) is greater than the adjustment pixel signal (PS_D), and may have a logic low level (L) in a time section where the adjustment ramp signal (Vrmp_D) is less than the adjustment pixel signal (PS_D).

The counter enable signal (CNT_EN) may have a logic high level (H) in a time section where the adjustment ramp signal (Vrmp_D) has a first slope (L1) that is a negative (−) slope. The counter 146 may be activated in response to the counter enable signal (CNT_EN) having a logic high level (H).

The activated counter 146 may perform counting in a time section where the comparison data (CMP_OUT) has a logic high level (H), and may output the counting result as ADC data (ADC_OUT). The ADC-processed image signal may correspond to a result value counted by the counter 146 during a pixel data counting period (PDC). The pixel data counting period (PDC) in the second analog gain mode may be greater than the pixel data counting period (PDC) in the first analog gain mode.

In the second analog gain mode, a value corresponding to a voltage difference between the image signal and the reference signal (i.e., a signal component from which reset noise is removed) may be obtained by subtracting a value obtained by AD-converting the reference signal from a value obtained by AD-converting the image signal.

Referring to FIGS. 2 to 4 and FIG. 7C, in the third analog gain mode, the operation of converting the adjustment pixel signal (PS_D) into image data may be performed during the readout period (RO). The readout period (RO) may correspond to a time period in which the ADC 140 receives the pixel signal (PS) from the source follower transistor (SF) based on the selection control signal (SEL) of a logic high level (H).

The pixel signal (PS) may be converted into the adjustment pixel signal (PS_D) by passing through the cap divider 142. The adjustment pixel signal (PS_D) may be divided into a reference signal and an image signal. The readout period (RO) may correspond to a time period in which the reference signal and the image signal are converted into digital values.

The third analog gain mode may be a mode in which an increase in the response (or image data) according to an increase in the intensity of incident light corresponds to a third gain value. In one embodiment, the third gain value of the third analog gain mode may correspond to a value that is greater than or equal to each of a first gain value of the first analog gain mode and a second gain value of the second analog gain mode.

The readout period (RO) may be divided into a reset period (RST) and a signal period (SIG). The reset period (RST) may be a time period in which the reference signal is subjected to ADC. The signal period (SIG) may be a time period in which the image signal is subjected to ADC.

In the reset period (RST), since the pixel reset signal (RG) temporarily has a logic high level (H), a pixel signal (PS) corresponding to the voltage of the reset floating diffusion region (FD) may be output from the pixel (PX). The pixel signal (PS) corresponding to the voltage of the reset floating diffusion region (FD) may be converted into the adjustment pixel signal (PS_D) by passing through the cap divider 142.

The comparison data (CMP_OUT) may have a logic high level (H) in a time section where the adjustment ramp signal (Vrmp_D) is greater than the adjustment pixel signal (PS_D), and may have a logic low level (L) in a time section where the adjustment ramp signal (Vrmp_D) is less than the adjustment pixel signal (PS_D).

The counter enable signal (CNT_EN) may have a logic high level (H) in a time section where the adjustment ramp signal (Vrmp_D) has a second slope (L2) that is a negative (−) slope. The counter 146 may be activated in response to the counter enable signal (CNT_EN) having a logic high level (H).

The activated counter 146 may perform counting in a time section where the comparison data (CMP_OUT) has a logic high level (H), and may output the counting result as ADC data (ADC_OUT). The ADC-processed reference signal may correspond to a result value counted by the counter 146 during the reset data counting period (RDC).

In the signal period (SIG), since the transfer signal (TG) temporarily has a logic high level (H), the pixel signal (PS) corresponding to the voltage of the floating diffusion region (FD) in which photocharges generated by the pixel (PX) are accumulated may be output from the pixel (PX). The voltage level of the pixel signal (PS) may be lowered in response to the amount of photocharges accumulated in the floating diffusion region (FD).

The pixel signal (PS) with the lowered voltage level may be converted into the adjustment pixel signal (PS_D) with the lowered voltage level by passing through the cap divider 142. The adjustment pixel signal (PS_D) in the signal period (SIG) may have a lower voltage level than the adjustment pixel signal (PS_D) in the reset period (RST) by a second range value (D2).

After lapse of a predetermined time from the beginning of the signal period (SIG), the ramp generator 130 may output a ramp output signal (Vrmp) having a second slope (L2) that is a negative (−) slope. The second slope (L2) of the ramp output signal (Vrmp) may be the same as the second slope (L2) of the ramp output signal (Vrmp) in the reset period (RST).

The comparison data (CMP_OUT) may have a logic high level (H) in a time section where the adjustment ramp signal (Vrmp_D) is greater than the adjustment pixel signal (PS_D), and may have a logic low level (L) in a time section where the adjustment ramp signal (Vrmp_D) is less than the adjustment pixel signal (PS_D).

The counter enable signal (CNT_EN) may have a logic high level (H) in a time section where the adjustment ramp signal (Vrmp_D) has a second slope (L2) that is a negative (−) slope. The counter 146 may be activated in response to the counter enable signal (CNT_EN) having a logic high level (H).

The activated counter 146 may perform counting in a time section where the comparison data (CMP_OUT) has a logic high level (H), and may output the counting result as ADC data (ADC_OUT). The ADC-processed image signal may correspond to a result value counted by the counter 146 during the pixel data counting period (PDC). The pixel data counting period (PDC) in the third analog gain mode may be greater than the pixel data counting period (PDC) in the second analog gain mode.

In the first analog gain mode, a value corresponding to a voltage difference between the image signal and the reference signal (i.e., a signal component from which reset noise is removed) may be obtained by subtracting a value obtained by AD-converting the reference signal from a value obtained by AD-converting the image signal.

As is apparent from the above description, the embodiments of the present disclosure can improve a signal to noise ratio (SNR) by compressing not only a ramp signal in a low-illuminance environment but also a voltage level range of a pixel signal in the low-illuminance environment.

The embodiments of the present disclosure can reduce the circuit area and power consumption required to implement the ramp generator configured to use a plurality of analog gains.

The embodiments of the present disclosure may provide a variety of advantageous effects capable of being directly or indirectly recognized.

Although a number of illustrative embodiments have been described, it should be understood that modifications and enhancements to the disclosed embodiments and other embodiments can be devised based on what is described and/or illustrated in the present disclosure. Furthermore, the embodiments may be combined to form additional embodiments.

What is claimed is:

1. An image sensing device comprising:
a ramp generator configured to generate a ramp signal;
a capacitance divider configured to output a first adjustment pixel signal by adjusting a voltage level range of a pixel signal to a first voltage level range value in a first analog gain mode, or configured to output a second adjustment pixel signal by adjusting a voltage level range of the pixel signal to a second voltage level range value in a second analog gain mode; and
a signal controller configured to control the ramp generator so that a waveform of the ramp signal has a first slope in each of the first analog gain mode and the second analog gain mode.

2. The image sensing device according to claim 1, wherein the capacitance divider includes:
a first capacitor connected between a first node and a second node, each of which receives the pixel signal as an input signal;
a second capacitor connected to a ground terminal; and
a first switch connected between the second node and the second capacitor, and configured to control a switching operation of the first switch in response to a first switch control signal.

3. The image sensing device according to claim 2, wherein the signal controller is configured to:
generate the first switch control signal based on the first analog gain mode or the second analog gain mode; and
control the first switch to be opened or closed based on the first switch control signal.

4. The image sensing device according to claim 2, wherein the signal controller is configured to:
control the first switch to be closed in the first analog gain mode; and
control the first switch to be opened in the second analog gain mode.

5. The image sensing device according to claim 2, wherein the capacitance divider is configured to
adjust a voltage level range of the pixel signal by capacity distribution according to the first capacitor, the second capacitor, and a first parasitic capacitor connected to the second node.

6. The image sensing device according to claim 2, wherein the capacitance divider further includes
a third capacitor connected to a third node to which the ramp signal is applied.

7. The image sensing device according to claim 6, wherein the capacitance divider is configured to
adjust a voltage level range of the ramp signal by capacity distribution according to the third capacitor and a second parasitic capacitor connected to the third node.

8. The image sensing device according to claim 1, wherein the capacitance divider includes:
a first capacitor connected between a first node and a second node, each of which receives the pixel signal as an input signal;
a fourth capacitor connected to a ground terminal;
a first switch connected between the second node and the fourth capacitor, and configured to control a switching operation of the first switch in response to a first switch control signal;
a third capacitor connected between a third node and a fourth node, each of which receives the ramp signal as an input signal;
a fifth capacitor connected to the ground terminal;
a second switch connected between the fourth node and the fifth capacitor, and configured to control a switching operation of the second switch in response to a second switch control signal; and
a shared line configured to connect the fourth capacitor to the fifth capacitor.

9. The image sensing device according to claim 8, wherein the capacitance divider is configured to
adjust a voltage level range of the pixel signal by capacity distribution according to the first capacitor, the fourth capacitor, the fifth capacitor, and a first parasitic capacitor connected to the second node.

10. The image sensing device according to claim 8, wherein the capacitance divider is configured to
adjust a voltage level range of the ramp signal by capacity distribution according to the third capacitor and a second parasitic capacitor connected to the fourth node.

11. The image sensing device according to claim 1, wherein
the second voltage level range value is greater than the first voltage level range value.

12. The image sensing device according to claim 1, wherein:
the first analog gain mode corresponds to a first illuminance environment; and
the second analog gain mode corresponds to a second illuminance environment, and
wherein
illuminance corresponding to the first illuminance environment is higher than illuminance corresponding to the second illuminance environment.

13. The image sensing device according to claim 1, wherein:
the capacitance divider is configured to output the second adjustment pixel signal by adjusting a voltage level range of the pixel signal to the second voltage level range value in a third analog gain mode; and
the signal controller is configured to control the ramp generator so that a waveform of the ramp signal has a second slope in the third analog gain mode.

14. The image sensing device according to claim 13, wherein
the second slope is gentler than the first slope.

15. The image sensing device according to claim 1, further comprising:
a comparator configured to generate comparison data by comparing one of the first adjustment pixel signal or the second adjustment pixel signal with the ramp signal; and
a counter configured to count the comparison data based on a counter enable signal.

16. An image sensing device comprising:
a pixel array configured to generate a pixel signal;
a signal controller configured to generate a ramp control signal and a switch control signal based on an analog gain mode corresponding to illuminance;
a capacitance divider configured to output a first adjustment pixel signal by adjusting a voltage level range of the pixel signal to a first voltage level range value based on the switch control signal, or configured to output a second adjustment pixel signal by adjusting a voltage level range of the pixel signal to a second voltage level range value;
a ramp generator configured to adjust a slope of a ramp signal based on the ramp control signal; and
a comparator configured to generate comparison data by comparing one of the first adjustment pixel signal or the second adjustment pixel signal with the ramp signal.

17. The image sensing device according to claim 16, wherein the capacitance divider includes:
a first capacitor connected between a first node and a second node, each of which receives the pixel signal as an input signal;
a second capacitor connected to a ground terminal;
a first switch connected between the second node and the second capacitor, and configured to control a switching operation of the first switch in response to a first switch control signal; and
a third capacitor connected to a third node to which the ramp signal is applied.

18. The image sensing device according to claim 17, wherein the capacitance divider is configured to
adjust a voltage level range of the pixel signal by capacity distribution according to the first capacitor, the second capacitor, and a first parasitic capacitor connected in the second node.

19. The image sensing device according to claim 16, wherein the capacitance divider includes:
a first capacitor connected between a first node and a second node, each of which receives the pixel signal as an input signal;
a fourth capacitor connected to a ground terminal;
a first switch connected between the second node and the fourth capacitor, and configured to control a switching operation of the first switch in response to a first switch control signal;
a third capacitor connected between a third node and a fourth node, each of which receives the ramp signal as an input signal;
a fifth capacitor connected to the ground terminal;
a second switch connected between the fourth node and the fifth capacitor. and configured to control a switching operation of the second switch in response to a second switch control signal; and
a shared line configured to connect the fourth capacitor to the fifth capacitor.

20. The image sensing device according to claim 19, wherein the capacitance divider is configured to
adjust a voltage level range of the pixel signal by capacity distribution according to the first capacitor, the fourth capacitor, the fifth capacitor, and a first parasitic capacitor connected in the second node.
